(19) United States
(12) Patent Application Publication
(10) Pub. No.: US 2009/0048888 A1
(43) Pub. Date: Feb. 19, 2009

(54) TECHNIQUES FOR CLAIM STAKING IN A PROJECT STAGE-BASED ENVIRONMENT

(76) Inventors: Michel Shane Simpson, American Fork, UT (US); Volker Gunnar Scheuber-Heinz, Pleasant Grove, UT (US); Lee Edward Lowry, Orem, UT (US); Stephen R. Carter, Spanish Fork, UT (US)

Correspondence Address: SCHWEGMAN, LUNDBERG & WOESSNER/NOVELL, PO BOX 2938, MINNEAPOLIS, MN, 55402, US

(21) Appl. No.: 11/838,568

(22) Filed: Aug. 14, 2007

(51) Int. Cl. G06Q 10/00

(52) U.S. Cl. 705/8

(57) ABSTRACT

Techniques for claim staking in a project stage-based environment are provided. A stakeholder is assigned for a project as a whole or a sub portion of the project. Access permissions are defined in response to the stakeholder, the project, and/or the sub portion. The access permissions are dynamically enforced across processing environments, stages within a same project, and stages within different projects when attempted changes are made to the project or the sub portion.

### BACKGROUND

Increasingly enterprises and governments are turning to technology to automate and streamline their internal operations and business processes. Furthermore, the advent of the Internet and the World-Wide Web (WWW) has allowed enterprises and governments to deliver goods and services in an automated and nearly instantaneous fashion across the entire globe.

With any good or service provided by an enterprise or a government, there can be potentially a myriad of activities and expenses associated with those activities, which the enterprise or government endures before the good or service is available in the marketplace for consumption.

For example, word processing software has to be initially defined, developed and tested before it can be released for sale. These activities are usually managed internally by high-salaried project managers. For the most part, the project managers are administrators with skill in acquiring other personnel and equipment within an enterprise to make a project move from conception and development to release. In some cases, projects are so large-within an enterprise that multiple layers of project managers are needed for any given project.

In large part, the industry has not been able to successfully automate and streamline the project management process. As a result, the cost of goods and services are likely unduly inflated and the time-to-market for goods and services is longer than it probably should be.

One reason for this lack of automation is the perceived complexity associated with project management in general. There are a variety of considerations such as laws, regulations, internal procedures that have to be followed. In addition, there may be limited personnel with specific skill sets some of which may be in high demand and unavailable within the enterprise and some of which the enterprise does not have and will have to contract out or hire in order to obtain.

Moreover, in a project staged-based environment multiple projects or pieces of a project from multiple different stages may be feeding a larger project upstream. The question as to who owns what and to who can define security restrictions on what quickly becomes problematic. A traditional rights-based model approach is not flexible enough and complicates project development and requires that dual systems be maintained (project management and security). Furthermore, the traditional rights-based model is not conducive to project collaboration.

Thus, what is needed is an automated and flexible mechanism, which allows for improved coordination between projects and between portions of a same project while currently and dynamically providing a flexible security approach.

### SUMMARY

In various embodiments, techniques for claim staking in a project staged-based environment are provided. More specifically, and in an embodiment, a method is provided for project stage-based claim staking. A principal stakeholder is assigned for an item of a project within a source stage of a source lifecycle that is associated with a source project. The source stage is associated with a source processing environment. Next, access permissions are acquired from the principal stakeholder within the source processing environment. Finally, the access permissions are enforced against other principals or other resources associated with the source project or different projects, which are associated with different stages and different processing environments.

### BRIEF DESCRIPTION OF THE DRAWINGS

FIG. 1 is a diagram of a method for project stage-based claim staking is provided, according to an example embodiment.

FIG. 2 is a diagram of another method for project stage-based claim staking is provided, according to an example embodiment.

FIG. 3 is a diagram of a project stage-based claim staking system, according to an example embodiment.

FIG. 4 is a diagram of another project stage-based claim staking system, according to an example embodiment.

### DETAILED DESCRIPTION

A “resource” includes a user, content, a processing device, a node, a service, an application, a system, a schema definition, a directory, an operating system (OS), a file system, a data store, a database, a policy definition, a configuration definition, a file, content, a World-Wide Web (WWW) service, a WWW page, groups of users, a digital certificate, an attestation, combinations of these things, etc. The terms “service,” “application,” and “system” may be used interchangeably herein and refer to a type of software resource that includes instructions, which when executed by a machine performs operations that change the state of the machine and that may produce output.

A “principal” is a special type of resource that performs one or more actions against other resources. So a principal may be a user or an automated service. A “principal stakeholder” is a type of principal that lays claim to a resource (item) of a particular project or to sets of items that can represent the project as a whole or sub portions of the project. The phrase “lays claim” means that for purposes of security and access permissions the principal stakeholder is the owner of that item or sets of items and can dictate and/or define the access permissions for the item or sets of items. The mechanism by which the principal stakeholder is assigned and performs claim-staking is defined in detail herein and below.

“Access permissions” are policy statements or conditions that define how an item or set of items for a project can be viewed, accessed, and/or modified. Some access permissions can also define how collaboration for the item or sets of items is to proceed. The types of access permissions and actions related thereto are described in detail herein and below.

In an embodiment, each resource is electronically defined and represented as having one or more attributes. Each attribute includes one or more name value pairs. For example, a server resource may include an attribute associated with its physical Internet Protocol (IP) address and that attribute may be represented by the following name value pair: “IP=100.1.1.10.” The server resource may also have its own identity (discussed below) and may include other attributes such as whether the IP address is static or dynamic, etc. Attributes may also include references to policy or even specific configuration details for a given processing environment that a resource is to be deployed to.

A “project” refers to the activity associated with an enterprise or government producing a good (product) or personal service (e.g., financial advice, etc.) for consumption in the marketplace. The activity for the project is defined in various stages of the project's lifecycle, such as by way of example only project definition, project development, project testing, project release, etc. Thus, a “project” is represented and electronically defined as a series of stages associated with the project's lifecycle. Each stage includes its own processing environment having its own or shared resources. So, a stage is represented and electronically defined as one or more resources and their relationships with other resources of the same stage or a different stage. A project may also be viewed as a type of resource.

A virtual project is one that includes other sub projects or nested projects. Some resources associated with a virtual project may be instantiated and ready for use while others are configured and instantiated according to policy.

Projects and virtual projects are defined via configuration data, metadata, policy, and other directives or statements that can be interpreted by and acted upon by other services or resources to logically assemble and define a collection of resources as a particular project or meta resource. As used here a project can include one or more virtual projects or references to nested sub and independent projects.

A “processing environment” refers to one or more physical processing devices organized within a local network. For example, several computers connected via a local area network (LAN) may collectively be viewed as a processing environment. The processing environment also refers to software configurations of the physical processing devices, such as but not limited to operating system, file system, directory service, etc. A single processing environment may be logically defined, such that it spans multiple different networks (e.g., multiple different LAN's, a LAN and a wide-area network (WAN), etc.).

An “identity service” refers to a special type of service that is designed to manage and supply authentication services and authentication information for resources. So, an identity service may authenticate a given resource for access to a variety of local and external services being managed by that identity service. A single resource may have multiple identity services. In addition the identity service itself may be viewed as a type of resource. In this manner, identity service may authenticate and establish trust with one another viewing one another as specific type of resource.

According to an embodiment, some example identity services are described in “Techniques for Dynamically Establishing and Managing Authentication and Trust Relationships,” filed on Jan. 27, 2004, and having the U.S. Ser. No. 10/765,523; “Techniques for Establishing and Managing a Distributed Credential Store,” filed on Jan. 29, 2004, and having the U.S. Ser. No. 10/767,884; and “Techniques for Establishing and Managing Trust Relationships,” filed on Feb. 3, 2004, and having the U.S. Ser. No. 10/770,677; all of which are commonly assigned to Novell, Inc., of Provo, Utah and the disclosures of which are incorporated by reference herein.

An identity service may also provide single sign-on services to a resource. That is, a resource may sign-on to an identity service and acquire identities and credentials to access a variety of other services or resources. In some cases, the identity service is modified or enhanced to perform some of the teachings presented herein and below.

A resource is recognized via an “identity.” An identity is authenticated via various techniques (e.g., challenge and response interaction, cookies, assertions, etc.) that use various identifying information (e.g., identifiers with passwords, biometric data, hardware specific data, digital certificates, digital signatures, etc.). A “true identity” is one that is unique to a resource across any context that the resource may engage in over a network (e.g., Internet, Intranet, etc.). However, each resource may have and manage a variety of identities, where each of these identities may only be unique within a given context (given service interaction, given processing environment, given virtual processing environment, etc.).

The identity may also be a special type of identity that the resource assumes for a given context. For example, the identity may be a “crafted identity” or a “semantic identity.” An example for creating and using crafted identities may be found in U.S. patent application Ser. No. 11/225,993; entitled “Crafted Identities;” filed on Sep. 14, 2005; and the disclosure of which is incorporated by reference herein. An example for creating and using semantic identities may be found in U.S. patent application Ser. No. 11/261,970; entitled “Semantic Identities;” filed on Oct. 28, 2005; and the disclosure of which is incorporated by reference herein.

A “modification” is a change that occurs in a resource. A change can be adding a new resource to a processing environment where it did not previously exist, an update to a resource, a bug fix to a resource, an alteration to procedures associated with a resource, an alteration to regulations associated with a resource, etc.

A “notification” is a communication regarding a modification. The notification can be a simple event communication or it can be more complex and include a variety of information with the notification, such as but not limited to an identity of a project, a modification type, an identity of a resource, a procedure to take in response to the notification, etc.

Various embodiments of this invention can be implemented in existing network architectures, security systems, data centers, and/or communication devices. Any particular architectural layout or implementation presented herein is provided for purposes of illustration and comprehension only and is not intended to limit aspects or embodiments of the invention.

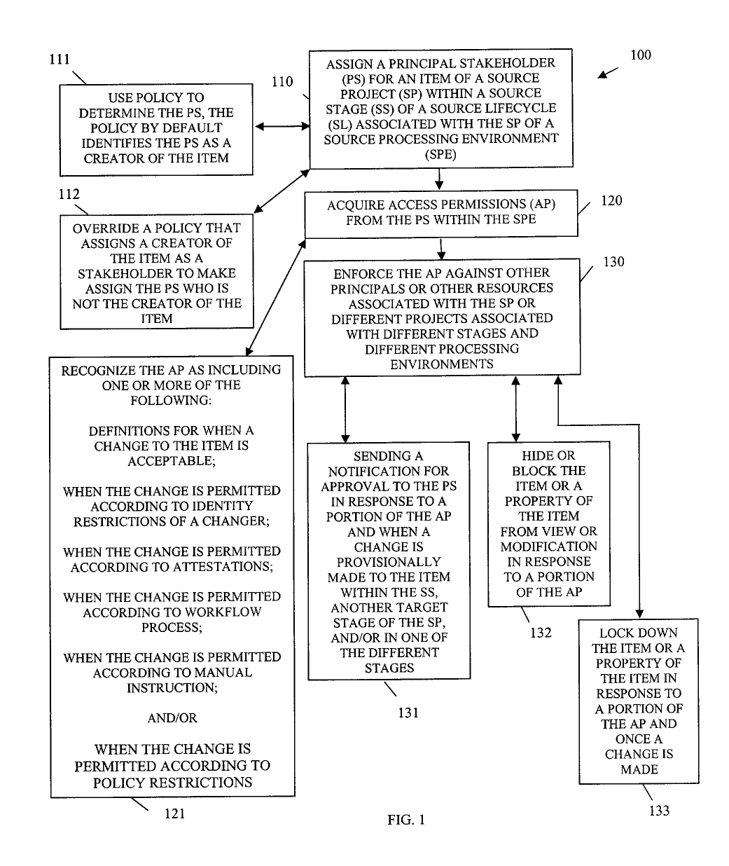

It is within this context, that various embodiments of the invention are now presented with reference to the FIGS. 1-4.

FIG. 1 is a diagram of a method 100 for project stage-based claim staking is provided, according to an example embodiment. The method 100 (hereinafter “stage-based claim-staking service”) is implemented as instructions in a machine-accessible and readable medium. The instructions when executed by a machine perform the processing depicted in FIG. 1. The stage-based claim-staking service is also operational over and processes within a network. The network may be wired, wireless, or a combination of wired and wireless.

As will be more fully described herein and below, the stage-based claim-staking service facilitates collaboration of resources (items) associated with a project's lifecycle from a particular stage of that lifecycle and ensures security (access permissions) are properly maintained during any particular collaboration attempt. The collaboration can occur within a same project, within a same processing environment, across different projects, and/or across different processing environments.

At 110, the stage-based claim-staking service assigns a principal stakeholder (owner for security purposes) for an item (resource or portion of a resource) of a project within a source stage of a source lifecycle. The resources of the source stage process within or are accessible from a source processing environment. Assignment of the principal stakeholder can occur in a variety of configurable manners.

For example, at 111, the stage-based claim-staking service uses policy to determine the principal stakeholder. The policy may by default identify an identity associated with the principal stakeholder based on the principal stakeholder being an initial creator of the item for the source project.

In another example, at 112, the stage-based claim-staking service overrides an existing policy that identifies a stakeholder for the item as being an initial creator of the item. In this case, the principal stakeholder, whom the stage-based claim-staking service assigns, is not the initial creator. So, the stage-based claim-staking service overrides the existing policy to make the principal stakeholder the owner of security rights to the item.

At 120, the stage-based claim-staking service acquires access permissions from the principal stakeholder (directly or indirectly as discussed below) within the source processing environment. A variety of mechanisms can facilitate the technique by which the stage-based claim-staking service acquires the access permissions from the principal stakeholder.

For example, at 121, the stage-based claim-staking service recognizes the access permissions as including one or more of the following: definitions for when a change to the item is considered to be acceptable; indications as to when the change is permitted according to identity-based restrictions; indications as to when the change is permitted according to attestations; indications as to when the change is permitted according to a particular workflow process; indications as to when the change is permitted according to manual instruction; and/or when the change is permitted according to policy restrictions.

At 130, the stage-based claim-staking service enforce the access permissions against other principals or other resources associated with the source project or even different projects associated with different stages and different processing environments.

The enforcement can be achieved remotely from the different processing environments or locally within each individual and different processing environment. The local enforcement can be achieved by acquiring the access permissions from the stage-based claim-staking service of from a third-party service, such as an identity service (discussed above and incorporated by reference herein and above). So, the enforcement processing can be decentralized but centrally controlled.

According to an embodiment, at 131, the stage-based claim-staking service sends a notification for approval to the principal stakeholder in response to enforcing at least a portion of the access permissions. The portion indicates that when a change is provisionally made to the item within the source stage, another target stage of the source project or in one of the different stages, the stage-based claim-staking service sends a notification to the principal stakeholder for approval of the provisional change. If the principal stakeholder approves the provisional change then it is committed and permitted to be made permanently.

In another embodiment, at 132, the stage-based claim-staking service hides or blocks the item or even a property or attribute associated with the item from view or modification in response to at least a portion of the access permissions. So, the access permissions can actively hide or prevent modification to the item or property/attribute associated with the item. The hiding and modification prevention can even be fine grain, such as when a particular stage, a particular project, or a particular principal cannot see or modify the item or property/attribute while other stages, projects, and principals can still see or modify the item or property/attribute. The hiding and modification prevention can be coarse grain with respect to all others or fine grain with respect to particular others or particular sets of others.

In yet another case, at 133, the stage-based claim-staking service locks down the item or a property/attribute of the item in response to at least a portion of the access permissions once a change is acceptably made or committed to that item or property/attribute. So, the access permissions can dictate certain additional actions to take or restrictions to enforce once a change is committed.

As an example illustration of a processing particular scenario for the stage-based claim-staking service consider the following situation. A master (source) project has item A and sub-items B and C that connect to item A. Feeder project 1 (different project from the master project) has item A and sub-item B. Feeder project 2 (another different project from the master project and project 1) has item A and sub-item C. When the user (principal) of begins to stage, the principal maps item A and sub-item B to a master stage if they (items A and sub-item B) are available for mapping. However, just because this mapping was done, nothing precludes a second user (another principal) to map some of the same items, namely item A. Depending upon the development dynamics this situation may not be desirable or wanted for multiple independent projects to simultaneously stage a same element into the master project and its stage.

To address this situation, the first principal when that principal does the initial mapping can select certain items, a namely A and B in the present example, and indicate that the first principal is “staking a claim” in them. Assuming policy permits, the stage-based claim-staking service makes the first principal the principal stakeholder in the claimed items, A and B. Then, any other principal, such as the second principal, who tries to map and stage those items, namely item A, is blocked or warned from proceeding. The second principal cannot stake a claim in item A or item B; but can still stake a claim in item C and proceed to stage item C.

This actually facilitates controlled collaborative teamwork in the master project where users (principals) do not clobber or step on each other's work. The claim-staking approach can be at the object (item or resource) level and/or at the attribute (item or resource property) level. This, as discussed above, can be extended to influence visibility of items to others (principals, stages, processing environments, projects, etc.). For example, if the first principal staged a claim in item B, this may mean that others (such as the second principal) cannot even see item B; not to mention the fact that the others cannot map, stage, and/or change item B.

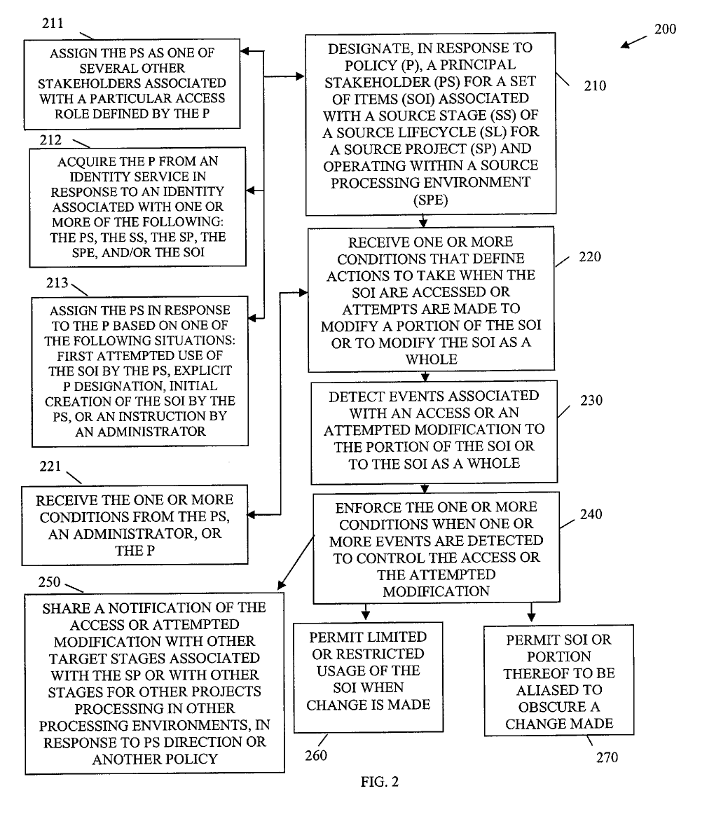

FIG. 2 is a diagram of another method 200 for project stage-based claim staking is provided, according to an example embodiment. The method 200 (hereinafter “project claim-staking service”) is implemented as instructions in a machine-accessible and readable medium. The instructions when executed by a machine perform the processing depicted in FIG. 2. The project claim-staking service is also operational over and processes within a network. The network may be wired, wireless, or a combination of wired and wireless.

The project claim-staking service represents an alternative and in some cases enhanced perspective to the stage-based claim-staking service represented by the method 100 discussed above with the FIG. 1.

At 210, the project claim-staking service designates, in response to policy, a principal stakeholder for a set of items associated with a source stage of a source lifecycle for a source project. The source stage and its resources (items) operate within a source processing environment. The set of items may be viewed as the source project as a whole, a sub portion of the project, an independent sub project associated with the project, a set of properties associated with the project, etc.

Again, a variety of similar or different situations may dictate when a particular principal stakeholder is designated for the set of items as the owner.

For example, at 211, the project claim-staking service assigns the principal stakeholder as one of several other principal stakeholders. The principal stakeholder and the several other principal stakeholders are each assigned to a same particular access role defined by policy. So, the principal stakeholder is designated in response to an access role associated with the principal stakeholder, such as administrator, project lead, development lead, etc. It is also noted that the role may be dynamically revoked or changed, such that the principal stakeholder designation may be revoked at any time based on events, policy, or condition that change the role of the principal stakeholder.

In another situation, at 212, the project claim-staking service acquires the policy initially from an identity service, such as the identity services discussed above and incorporated by reference herein. The policy is dynamically acquired in response to an identity associated with one or more of the following: the principal stakeholder, the source stage, the source project, the source processing environment, and/or the set of items.

In yet another case, at 213, the project claim-staking service assigns the principal stakeholder in response to the policy based on one of the following situations: first attempted use of the set of items made by the principal stakeholder, explicit designation by the policy, initial creation of the set of items by the principal stakeholder, and/or an instruction by an administrator.

At 220, the project claim-staking service receives one or more conditions that define actions to take when the set of items are accessed or attempts are made to modify a portion of the set of items or to modify the set of items as a whole. A variety of actions may be taken some of which were discussed above with respect to the access permissions of the method 100 of the FIG. 1. Actions can be taken before or after a change is committed to the set of items, during a change, and/or after a change is proposed or committed.

In an embodiment, at 221, the project claim-staking service receives the one or more conditions directly from the principal stakeholder, an administrator, and/or the policy.

At 230, the project claim-staking service detects events associated with an access or an attempted modification to the portion of the set of items or the set of items as a whole. Detection can be made via embedded triggers on the portion or the set of items, via monitoring of actions taken to or against the portion or the set of items, etc.

At 240, the project claim-staking service enforces the one or more conditions when one or more of the events are detected to control the access or the attempted modification. Some of the conditions were discussed above with respect to the method 100 of the FIG. 1 and defined via the access permission and their defined restrictions. Some additional examples follow as well.

In an embodiment, at 250, the project claim-staking service shares a notification of the access or the attempted modification with other target stages associated with the source project or with other stages for other projects processing in other processing environments. This sharing is done in response to direction supplied by the principal stakeholder or in response to another policy.

In another situation, at 260, the project claim-staking service permits limited or restricted usage of the set of items when a change is made. So, if a change is permitted a type of change that occurred may dictate that subsequent usage of the changed set of items is restricted or limited in some manner.

In still another case, at 270, the project claim-staking service permits the set of items or any portion thereof to be aliased for purposes of obscuring any change made. For example, an enterprise may be using external contractors and certain changes may not be desirable to disclose to those contractors. In such a situation, the change can be aliased so the contractors are unaware of its association to the original set of items and restricted from viewing the aliased set of items. A variety of other situations may be beneficially used with the aliasing technique described and the example presented was for illustrative purposes only and is not intended to limit the invention to any particular embodiment.

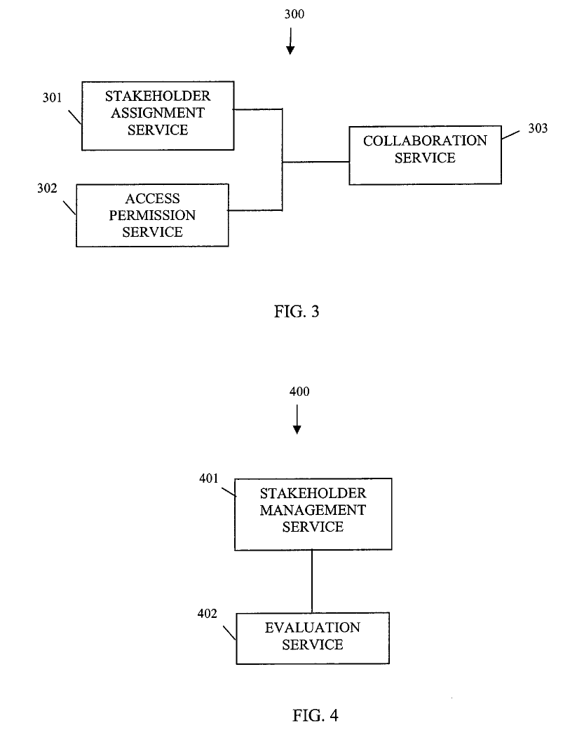

FIG. 3 is a diagram of a project stage-based claim staking system 300, according to an example embodiment. The project stage-based claim staking system 300 is implemented as instructions on or within a machine-accessible and readable medium. The instructions when executed by one or more machines perform various aspects of the processing depicted with respect to the methods 100 and 200 of the FIGS. 1 and 2, respectively. The project stage-based claim staking system 300 is also operational over a network and the network may be wired, wireless, or a combination of wired and wireless.

The project stage-based claim staking system 300 includes a stakeholder assignment service 301 and an access permission service 302. In an embodiment, the project stage-based claim staking system 300 also includes a collaboration service 303. Each of these components and their interactions with one another will now be discussed in turn.

The stakeholder assignment service 301 is implemented in a machine-accessible and readable medium and is to process on a first machine associated with a first processing environment and a first stage of a first lifecycle for a first project. Example processing associated with the stakeholder assignment service 301 was described in detail above with reference to the staged-based claim-staking service represented by the method 100 of the FIG. 1 and with respect to the project claim-staking service represented by the method 200 of the FIG. 2.

The stakeholder assignment service 301 designates a principal stakeholder from an item of the first lifecycle in response to a policy. Designation of the principal stakeholder can occur in a variety of manners according to the policies.

For example, the policy may permit a first requesting principal to request designation as the principal stakeholder. The policy may dictate that the creator be designated the principal stakeholder. In other cases, the policy may dictate that the first principal to access the item is to be the principal stakeholder. Designation can also be made explicit via an identity or role associated with the principal stakeholder and defined via the policy. Other circumstances can also exist. Any configurable circumstance that can be defined in the policy may be used for the stakeholder assignment service 301 to designate the principal stakeholder.

The access permission service 302 is implemented in a machine-accessible and readable medium and is to process on the first machine or a different machine within the first processing environment or a different processing environment. Example processing associated with the access permission service 302 was described in detail above with reference to the staged-based claim-staking service represented by the method 100 of the FIG. 1 and with respect to the project claim-staking service represented by the method 200 of the FIG. 2.

The access permission service 302 defines access permissions for the item as defined or supplied by the principal stakeholder; but, subject to other different policy restrictions. In other words, there may be limits placed on what access permissions that the principal stakeholder defines or supplies. It is also noted, as detailed above, that some access permissions may be supplied or defined by others, such as an administrator, to augment, replace, and/or supplement what the principal stakeholder supplies.

According to an embodiment, the access permissions are acquired within a local processing environment via an identity service, such as the identity service discussed and incorporated by reference above. In fact, any trusted third-party service can supply the access permissions to any requesting local processing environment. The access permissions are then enforced within that local processing environment when a collaboration attempt is made on the item or a portion (property/attribute) of the item.

The identity service or trusted third-party service can also be used to dynamically propagate a change made in the local processing environment back to the first stage, other first stages of the first project, and/or other stages associated with the other entirely different projects.

In an embodiment, at least one access permission restricts the item or a property of the item from being viewed by a number of other principals. In another situation, the access permissions define: who can view or access the item or properties of the item, when a change is permissible, how and when notification of the change is to occur, and what actions are permissible on the item or the properties when the change occurs.

In an embodiment, the project stage-based claim staking system 300 also includes a collaboration service 303. The collaboration service 303 is implemented in a machine-accessible and readable medium and is to process on one or more machines of the network. The network is a wide-area network (WAN), such as but not limited to the Internet and the World-Wide Web (WWW).

The collaboration service 303 permits the item to be collaborated on across other first stages or other stages associated with other lifecycles or other projects that process in other processing environments. The collaboration is restricted based on the access permissions during any particular collaboration attempt.

FIG. 4 is a diagram of another project stage-based claim staking system 400, according to an example embodiment. The project stage-based claim staking system 400 is implemented as instructions on or within a machine-accessible and readable medium. The instructions when executed by a machine perform various aspects of the processing depicted with respect to the methods 100 and 200 of the FIGS. 1 and 2, respectively and the processing associated with the system 300 of the FIG. 3. The project stage-based claim staking system 400 is also operational over a network and the network may be wired, wireless, or a combination of wired and wireless. The network is a WAN, such as but not limited to the Internet and the WWW.

The project stage-based claim staking system 400 includes a stakeholder management service 401 and an evaluation service 402. Each of these components and their interactions with one another will now be discussed in turn.

The stakeholder management service 401 is implemented in a machine-accessible and readable medium and is to process on a machine associated with a first processing environment and a first stage of a first lifecycle for a first project. Example processing of the stakeholder management service 401 was described in detail above with reference to the methods 100 and 200 of the FIGS. 1 and 2, respectively, and with reference to the system 300 of the FIG. 1.

The stakeholder management service 401 assigns a principal stakeholder to an item of the first project, a set of items for the first project, or a property associated with the item. Moreover, the stakeholder management service 401 is to acquire and associate conditions for: what the principal stakeholder is associated to, which define when changes are permissible for what the principal stakeholder is assigned to; and what actions to take with the changes that are permitted. The conditions are enforced by the evaluation service 402 during the first lifecycle of the first project within the first processing environment and other processing environments.

In an embodiment, the set of items represent the first project as a whole. In another case, a number of different items or sets of items associated with the first project have one or more different stakeholders assigned to them and other conditions that the evaluation service 402 enforces within the first processing environment or the other processing environments. In other case, a number of different items or set of items associated with the first project have no stakeholder and no conditions associated with them for access and changes made to them.

The evaluation service 402 is implemented in a machine-accessible and readable medium and is to process on the machine within the first processing environment and other machines associated with other processing environments. In other words, multiple instances of the evaluation service 402 processes on the network independent of one another. Example processing of the evaluation service 402 was described in detail above with reference to the methods 100 and 200 of the FIGS. 1 and 2, respectively and with reference to the system 300 of the FIG. 3.

As stated above, the evaluation service 402 enforces the conditions during the first lifecycle within the first processing environment or during other lifecycles associated with other different projects and different processing environments.

According to an embodiment, the evaluation service 402 dynamically acquires the conditions within the other and different processing environments from an identity service or a trusted third-party service for local enforcement within the other processing environments.

It is now appreciated how project collaboration can be achieved with flexible custom security using a staged-based and claim-staking approach.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
assigning a principal stakeholder for an item of a source project within a source stage of a source lifecycle associated with the source project, wherein the source stage is associated with a source processing environment;
acquiring access permissions from the principal stakeholder within the source processing environment; and
enforcing the access permissions against other principals or other resources associated with the source project or different projects associated with different stages and different processing environments.

2. The method of claim 1, wherein assigning further includes using a policy to determine the principal stakeholder, wherein the policy by default identifies a creator of the item as the principal stakeholder.

3. The method of claim 1, wherein assigning further includes overriding a policy that assigns a creator of the item as a stakeholder for the item for purposes of making the principal stakeholder who did not create the item the stakeholder for the item.

4. The method of claim 1, wherein acquiring further includes recognizing the access permissions as including one or more of the following: definitions for when a change to the item is acceptably committed for movement between target stages of the source project or for movement between the other stages of the other projects, when the change to the item is permitted according to identity restrictions of a changer, when the change to the item is permitted according to attestations, when the change to the item is permitted according to workflow process, when the change to the item is permitted according to manual instruction, and when the change to the item is permitted according to policy restrictions.

5. The method of claim 1, wherein enforcing further includes sending a notification for approval to the principal stakeholder in response to a portion of the access permissions and when a change is provisionally made to the item within the source stage, another target stage of the source project, or in one of the different stages.

6. The method of claim 1, wherein enforcing further includes hiding or blocking the item or a property of the item from view or modification in response to a portion of the access permissions.

7. The method of claim 1, wherein enforcing further includes locking down the item or a property of the item from any changes in response to a portion of the access permission once a defined change is made to the item or the property.

8. A method, comprising:
designating, in response to a policy, a principal stakeholder for a set of items associated with a source stage of a source lifecycle for a source project and operating within a source processing environment;
receiving one or more conditions that define actions to take when the set of times are accessed or attempts are made to modify a portion of the set of items or to modify the set of items as a whole;
detecting events associated with an access or an attempted modification to the portion of the set of items or the set of items as a whole; and
enforcing the one or more conditions when one or more events are detected to control the access or the attempted modification.

9. The method of claim 8, wherein designating further includes assigning the principal stakeholder as one or several other stakeholders associated with a particular access role defined by the policy.

10. The method of claim 8, wherein designating further includes acquiring the policy from an identity service in response to one or more of the following: an identity associated with the designated principal stakeholder, an identity associated with the source stage, an identity associated with the source project, an identity associated with the source processing environment, and an identity associated with the set of items.

11. The method of claim 8, wherein designation further includes assigning the principal stakeholder in response to the policy based on one of the following situations: a first attempted use of the set of items done by the principal stakeholder, explicit designation in the policy of an identity associated with principal stakeholder, initial creation of the set of items created by the principal stakeholder, and an instruction from an administrator.

12. The method of claim 11, wherein receiving further includes receiving the one or more conditions from one or more of the following: the principal stakeholder, an administrator, and the policy.

13. The method of claim 8 further comprising, sharing a notification of the access or the attempted modification with other target stages associated with the source project or with other stages for other projects processing in other processing environments, wherein the sharing of the notification also done in response to another policy or in response to principal stakeholder direction.

14. The method of claim 8 further comprising, permitting limited or restricted continued usage of the sets of items when the attempted modification is accepted and a change to set of items or the portion of the set of items is made.

15. The method of claim 8 further comprising, permitting the set of items or the portion of the set of items to be aliased to obscure a change that occurs when the attempted modification is accepted.

16. A system, comprising:
a stakeholder assignment service implemented in a machine-accessible and readable medium and to process on a first machine associated with a first processing environment and a first stage of a first lifecycle for a first project; and
a access permission service implemented in a machine-accessible and readable medium and to process on the first machine or a different machine within the first processing environment or a different processing environment; and
wherein the stakeholder assignment service is to designate a principal stakeholder for an item of the first lifecycle in response to a policy, and wherein the access permission service is to define access permissions for the item as defined and supplied by the principal stakeholder.

17. The system of claim 16 further comprising, a collaboration service implemented in a machine-accessible and readable medium and to process on one or more machines of a network, wherein the collaboration service is to permit the item to be collaborated on across other first stages or other stages associated with other lifecycles of other projects that process in other processing environments, wherein collaboration is restricted based on the access permissions during any particular collaboration attempt.

18. The system of claim 17, wherein the access permissions are acquired within a local processing environment via an identity service or other third-party trusted service and enforced within that local processing environment when the particular collaboration attempt is made.

19. The system of claim 18, wherein the identity service or the other trusted third-party service dynamically propagates a change made in the local processing environment to the first stage, the other first stages, or the other stages associated with the first project or the other projects.

20. The system of claim 16, wherein at least one access permission restricts the item or a property of the item from being viewed by a number of other principals.

21. The system of claim 16, wherein the access permissions define who can view or access the item or properties of the item, when a change is permissible, how and when notification of the change is to occur, and what actions are permissible on the item or the properties when the change occurs.

22. A system, comprising:
a stakeholder management service implemented in a machine-accessible and readable medium and to process on a machine associated with a first processing environment and a first stage of a first lifecycle for a first project; and
an evaluation service implemented in a machine-accessible and readable medium and to process on the machine within the first processing environment and to process on other machines associated with other processing environments;
wherein the stakeholder management service is to assign a principal stakeholder to an item of the first project, a set of items for the first project, or a property associated with the item, and wherein the stakeholder management service is to acquire and associate conditions for what the principal stakeholder is assigned to that define when changes are permissible for what the principal stakeholder is assigned to and what actions to take with the changes that are permitted, and wherein the conditions are enforced by the evaluation service during the first lifecycle of the first project within the first processing environment and the other processing environments.

23. The system of claim 22, wherein the set of items represent the first project as a whole.

24. The system of claim 22, wherein the evaluation service is to dynamically acquire the conditions within the other processing environments from an identity service or a trusted third-party service for local enforcement within the other processing environments.

25. The system of claim 22, wherein a number of different items or sets of items associated with the first project have one or more different stakeholders assigned to them and other conditions that the evaluation service enforces within the first processing environment and the other processing environments.

26. The system of claim 22, wherein a number of different items or sets of items associated with the first project have no stakeholder and no conditions associated with them for access and changes made to them.
